(19) United States
(12) Patent Application Publication
(10) Pub. No.: US 2008/0090456 A1
(43) Pub. Date: Apr. 17, 2008

(54) SHIELDING CONTACT FOR A CONNECTOR HOUSING

(76) Inventors: Jean Francois Bernat, Sartrouville (FR); Jean-Merri de Vanssay, Paris (FR); Alexandre Mermaz, Paris (FR)

Correspondence Address: HAYES SOLOWAY P.C., 3450 E. SUNRISE DRIVE, SUITE 140, TUCSON, AZ, 85718, US

(21) Appl. No.: 11/861,036

(22) Filed: Sep. 25, 2007

(30) Foreign Application Priority Data
Oct. 12, 2006 (DE) 20 2006 015 641.0

(51) Int. Cl. H01R 13/648

(52) U.S. Cl. 439/607

(57) ABSTRACT

In order to produce a connection between a shielding sleeve (10) of a connector housing (1) and an inner as well as an outer braided shield (7, 8) of an electric cable (3), the invention proposes to provide the shielding sleeve (10) with a contact part (11), the end piece (14) of which has an omega-like shape and regionally encompasses the braided shield (7, 8) in a contacting fashion, wherein an additional springable contact tab (13) protruding out of the contact part (11) is provided for contacting the braided shield (8).

### BACKGROUND OF THE INVENTION

1. Field of the Invention

The invention pertains to a shielding contact for connecting an electrically shielded connector housing to an electric cable that is equipped with at least one braided shield.

A shielding contact of this type is required for ensuring the shielding effect of shielded electric cables against interfering radiation through a plug-and-socket connection.

2. Description of the Related Art

Many different versions for connecting a connector with shielding effect to the shield of an electric cable are known.

For example, U.S. Pat. No. 6,783,397 describes a connector, the two-part shielding housing of which features a ribbed metal strip on its cable connection side, wherein this ribbed metal strip is bent around the cable sheath in order to secure the electric cable.

In addition, U.S. Pat. No. 7,052,292 discloses a connector with a grounding structure that features an oval ring or is bent into an oval ring and ultimately contacts the shield of two adjacently arranged differential signaling lines. In this case, the ring simultaneously serves for retaining the signaling lines.

### SUMMARY OF THE INVENTION

The invention is based on the objective of realizing a shielded connector housing with a shielding contact of the initially cited type in such a way that a simple connection between the braided shield of an electric cable and a shielding sleeve that surrounds the plug-in contacts in a contact carrier can be produced without tools.

This objective is attained in that a contact carrier arranged in the connector housing is surrounded by a shielding sleeve with a contact part, by means of which an electrically conductive connection with the shield of the electric cable can be produced, wherein the contact part encompasses the outer shield or the inner shield in a contacting fashion with an end piece of omega-like shape.

The described connector housing with a surrounding shielding sleeve is intended for transferring shielded signaling lines and for forwarding supply voltages or supply currents, respectively.

The advantages attained with the invention can be seen, in particular, in that the shielding sleeve is realized with a shielding contact that is simply snapped on the cable shield of the shielded electric cable in order to transfer the shield potential to the connector. For this purpose, the shielding contact is realized in the form of a contact part that is exposed on three sides and can be easily bent onto the cable shield without tools in order to produce a clamping connection with a so-called omega end piece. The omega end piece approximately has the shape of a pipe section, the cross-section of which extends over three-quarters of a circle and features outwardly bent segments such that it corresponds to the Greek letter omega (Ω). In addition, a contact tab that is exposed on three sides and makes it possible to realize an additional contact is integrated into the contact part.

It is advantageous that several variations of connections can be used for producing a connection between the connector and the shield of the electric cable with the omega end piece:

1. The contact part acts upon an outer shield of an electric cable with the omega end piece.

2. The contact part acts upon an inner shield of a correspondingly realized electric cable with the omega end piece, wherein the tab inevitably acts upon the inner shield as well.

3. The contact part acts upon the outer shield with the omega end piece and upon the inner shield with the contact tab.

### BRIEF DESCRIPTION OF THE DRAWINGS

One embodiment of the invention is illustrated in the figures and described in greater detail below. The figures show:

FIG. 1 is a connector with an electric cable;

FIG. 2 is a contact carrier of the connector;

FIG. 3a is a contact carrier with a surrounding shielding sleeve that features an angled contact part;

FIG. 3b is an end piece of the contact part that encompasses the cable;

FIG. 4a is a contact carrier with a partially stripped electric cable;

FIG. 4b is the contact carrier with surrounding shielding sleeve and angled contact part;

FIG. 4c is the contact carrier with surrounding shielding sleeve and an end piece that contacts the outer shield of the electric cable;

FIG. 5a is the contact carrier with shielded signaling lines;

FIG. 5b is the contact carrier with surrounding shielding sleeve and angled contact part, and

FIG. 5c is the contact carrier with surrounding shielding sleeve and an end piece that contacts the inner shield of the electric cable.

### DESCRIPTION OF THE PREFERRED EMBODIMENTS

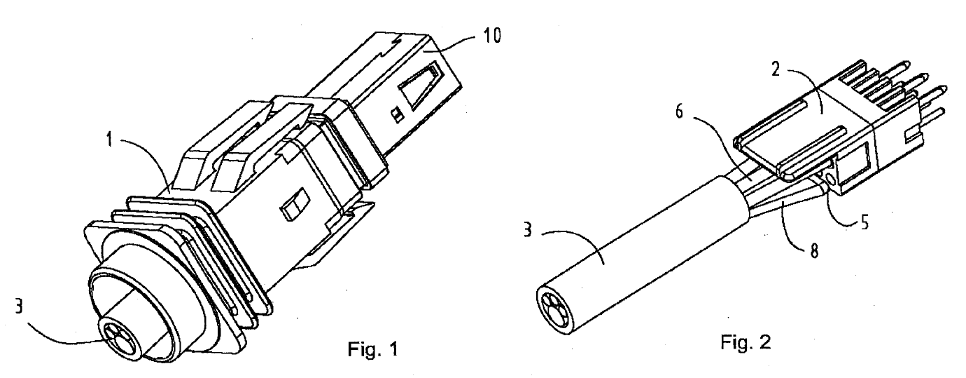

FIG. 1 shows a so-called push-pull connector with a contact carrier 2 that is surrounded by a shielding sleeve 10, on which a connector housing 1 is displaceably arranged, as well as an electric cable 3 that contains signaling lines 5 and power supply lines 6.

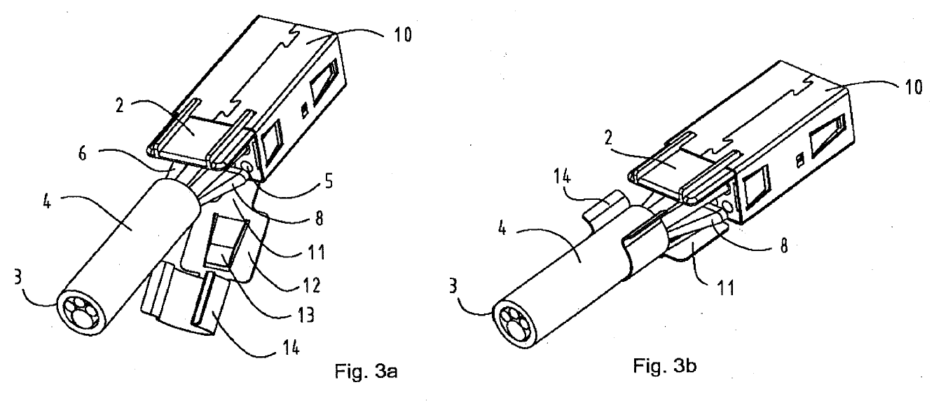

FIG. 2 shows the contact carrier 2 with electric plug-in contacts and the electric cable 3 connected thereto, namely without the surrounding connector housing 1. In this case, the signaling lines 5 are surrounded by a common inner shield 8.

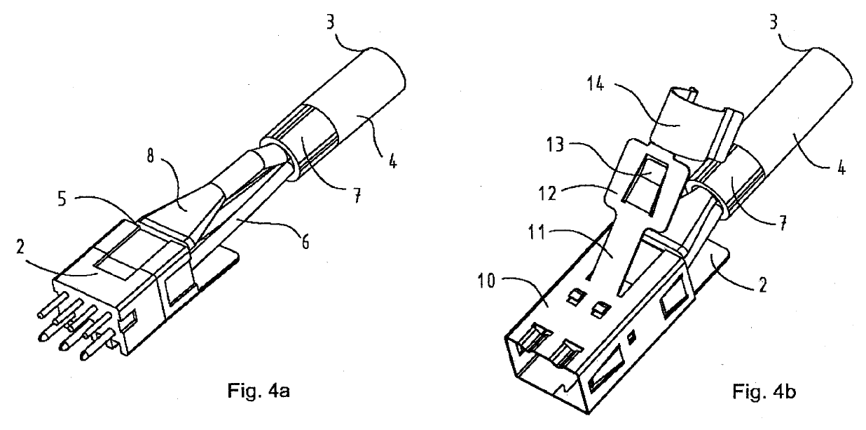

FIG. 3a shows the electrically insulating contact carrier 2 with the electric lines 5, 6 of the cable 3, as well as the electrically conductive shielding sleeve 10 that surrounds the contact carrier 2 and is provided for shielding purposes. A contact part 11 with an end piece 14 of omega-like shape is integrally formed onto the shielding sleeve 10. A nearly square surface 12 with a contact tab 13 that is exposed on three sides and points toward the electric cable is provided within the contact part between the end piece 14 and its connection to the shielding sleeve 10, wherein said contact tab ensures that a common inner shield 8 of the signaling lines 5 is also contacted.

According to FIG. 3b, the angled contact part 11 is bent in the direction of the electric cable 3 in such a way that the end piece 14 encompasses the sheath 4 of the electric cable 3 in a clamping fashion with its omega-like structure.

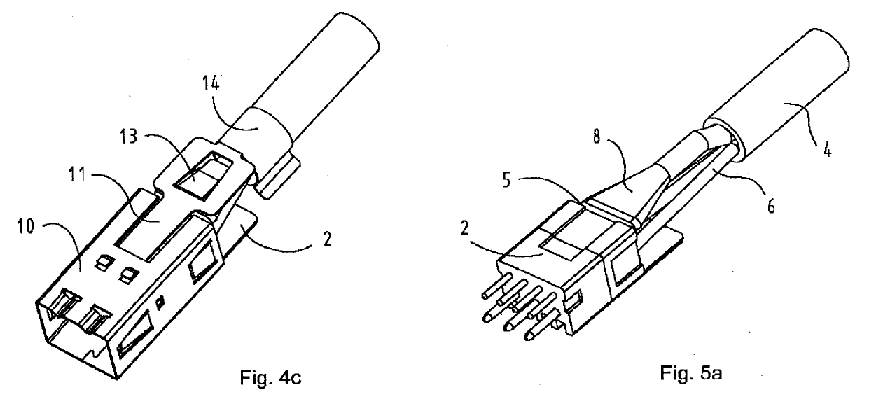

FIG. 4a shows the contact carrier 2 with the electric cable 3 that features an exposed outer shield 7 for the entire cable and another common inner shield 8 for the signaling lines 5 only underneath its outer sheath 4.

FIG. 4b shows the contact carrier 2 with the shielding sleeve 10 that also features an angled contact part 11 that contacts the outer shield 7 with the omega end piece 14 in FIG. 4c, wherein the contact tab 13 simultaneously contacts the inner shield 8.

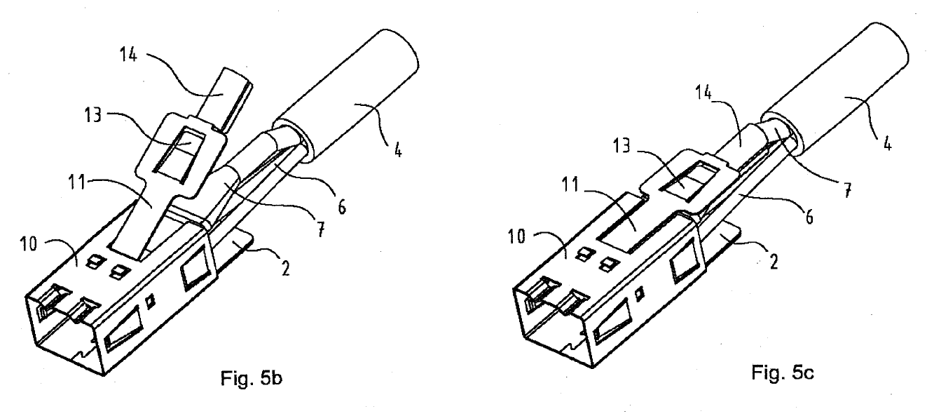

Analogous to the cycle of FIG. 4, FIGS. 5a, 5b, 5c also show how the omega end piece 14 of the shielding sleeve 10 and the contact tab 13 merely encompass and contact the inner shield 8 of the signaling lines 5 in a clamping fashion.

What is claimed is:

1. A shielding contact for connecting an electrically shielded connector housing to an electric cable that is equipped with at least one braided shield, wherein
a contact carrier is arranged in the connector housing and surrounded by a shielding sleeve with a contact part, wherein said contact carrier makes it possible to produce an electrically conductive connection with the shield of the electric cable, and
wherein the contact part encompasses the outer shield or the inner shield in a contacting fashion with an end piece of omegalike shape.

2. The shielding contact according to claim 1, wherein
the contact part is exposed on three sides and therefore springably shaped out of the shielding sleeve.

3. The shielding contact according to claim 1, wherein
the springable contact tab protruding out of the contact part is exposed on three sides and provided for contacting the inner shield of the electric cable.
